(19) United States
(12) Patent Application Publication
(10) Pub. No.: US 2013/0304868 A1
(43) Pub. Date: Nov. 14, 2013

(54) System and method for communicating and managing data

(71) Applicant: NOVATIUM SOLUTIONS PVT LTD, Chennai (IN)

(72) Inventors: Alok Singh, Chennai (IN); G. Vinod Kumar, Chennai (IN); Gowrishankar Radhakrishnan, Chennai (IN)

(73) Assignee: NOVATIUM SOLUTIONS PVT LTD, Chennai (IN)

(21) Appl. No.: 13/663,464

(22) Filed: Oct. 29, 2012

(30) Foreign Application Priority Data
May 8, 2012 (IN) 1797/CHE/2012

(51) Int. Cl. G06F 15/16

(52) U.S. Cl. 709/219

(57) ABSTRACT

A system and method for communicating and managing data among a plurality of user devices are provided. The system comprises a utility computing agent installed in each of the user devices, the utility computing agent configured for managing data synchronization among the plurality of user devices, a central storage unit coupled to each of the user devices via a data communication network, the central storage unit configured for being a master storage repository, and a communication agent configured for communicating content from the central storage unit to at least one of the user devices.

### REFERENCE TO RELATED APPLICATIONS

This application claims priority from an Indian patent application no. 1797/CHE/2012 filed on 8 May 2012, which is hereby incorporated herein in its entirety.

### FIELD OF INVENTION

The invention generally relates to data communication systems and methods, and more particularly to a system and method for maintaining data synchronization among a plurality of user devices.

### BACKGROUND OF THE INVENTION

Personal Computers and portable electronic devices such as cell phones, personal digital assistants (PDAs), and wireless email terminals have become an indispensable part of everyday life for many people. It is not uncommon for individuals to employ multiple devices for managing their personal communications, schedules, address books, contact lists, task lists, and the like.

Typically, each separate device will include provisions for storing data related to the primary functions of the device. However, the data stored on each device may be significantly different. For example, data stored on the work computer of a user may be different from data stored in the home computer of the user. Nonetheless, there may be significant overlap between the data stored on both computers.

When data can be added and modified on any one of a plurality of devices it is imperative that such additions and changes made on one device are propagated to the other user devices which store the same or related data. At present there is no system or mechanism available for maintaining consistency across a plurality of different devices.

A number of data synchronization protocols have been developed for performing data synchronization between various data storage devices. However, such data synchronization protocols are geared only toward synchronizing data between two devices. They do not provide a mechanism for synchronizing several devices either in parallel or in sequence. Some devices may support multiple synchronization protocols and may be adapted to synchronize with more than one device. Nonetheless, all such devices are adapted for synchronizing data between only two devices at any given time. In cases where an individual has more than two devices sharing common data, the two-way synchronization protocols currently available are insufficient to eliminate data inconsistencies between all of a user's devices.

Another problem associated with current computing and/or storage devices is the absence of a guaranteed back-up mechanism. Many of the back-up mechanisms described in the prior art need human intervention for initiating the setup and maintenance thereafter. Further, many of the backup solutions that are described in the art are locally available or through the web and need a high level of control and configuration from the user.

Furthermore, when it comes to existing computing and/or storage devices, there is no mechanism to provide a consolidated view and access to the comprehensive data that exists across multiple connected devices that are placed in different locations. For this purpose, the user is compelled to use cumbersome technical solutions to obtain a single window view of all the data that the user has stored.

Hence, there exists a need for an efficient and reliable system and method for managing user data that is distributed across multiple devices placed in different locations.

### BRIEF DESCRIPTION OF THE INVENTION

The above-mentioned shortcomings, disadvantages and problems are addressed herein, which will be understood by reading and understanding the following specification.

In one embodiment, a system for communicating and managing data in a plurality of user devices is provided. The system comprises a utility computing agent installed in each of the user devices, the utility computing agent configured for managing data synchronization among the plurality of user devices, a central storage unit coupled to each of the user devices via a data communication network, the central storage unit configured for being a master storage repository, and a communication agent configured for communicating content from the central storage unit to at least one of the user devices.

In another embodiment, a data management system for managing data among a plurality of user devices, each adapted to store data of a user, is provided. The data management system comprises a server side component comprising a central storage unit adapted to interface with each of the user devices via a data communication network, the central storage unit configured for being a master storage repository. The data management system further comprises a client side component comprising a utility computing agent installed in each of the user devices, the utility computing agent configured for managing data synchronization among the plurality of user devices, and further configured for supporting a plurality of data synchronization protocols for synchronizing data among the plurality of user devices; and a communication agent configured for communicating content from the central storage unit to at least one of the user devices.

In yet another embodiment, a method of communicating and managing data in a plurality of user devices is provided. The method comprises registering a user device at a central storage unit, maintaining a change log for each registered user device, comparing the change log to a central log maintained at the central storage unit to determine the need for synchronizing, and synchronizing data on the central storage unit with data on the registered user device upon determining the need for synchronizing.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an environment in which the invention works;

FIG. 2 shows a block diagram of a system for communicating and managing data, as described in an embodiment;

FIG. 3 shows a block diagram of a data management system for managing data, as described in another embodiment; and

FIG. 4 shows a flow diagram depicting a method of communicating and managing data, as described in another embodiment.

### DETAILED DESCRIPTION OF THE INVENTION

In the following detailed description, reference is made to the accompanying drawings that form a part hereof, and in which are shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The present invention provides a system and method for maintaining data synchronization across a plurality of user devices adapted to store at least a part of a user's data. The data may include personal data of the user such as contact lists, phone numbers, address books, email addresses, appointment calendars, task lists, notes, user documents, photographs, audio-video content and so forth.

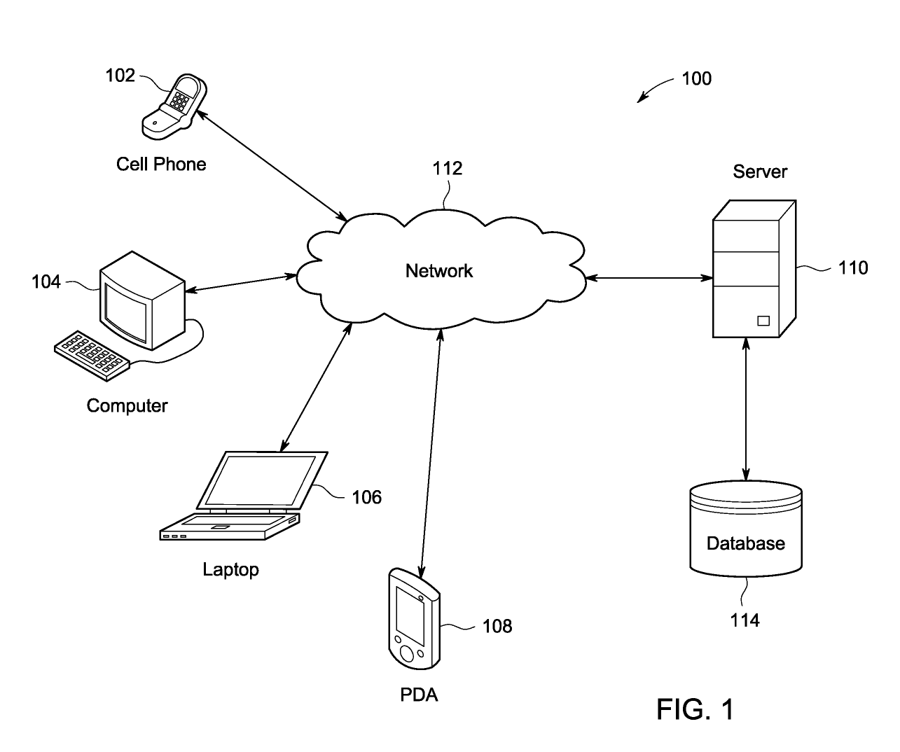

FIG. 1 shows a sample universe of various user devices on which a user may store some or all of his or her data. The user desires to maintain consistent data across all of the various user devices. Each user device is a communication device that is capable of communicating data over a public network. In the example shown in FIG. 1, the user has access to multiple user devices such as a cellular phone 102, a personal computer 104, a laptop 106 and a personal digital assistant 108. Each of the user devices are connected to a TCP/IP based network, such as the Internet 112. Each of the communication devices, smart phone 102, personal computer 104, laptop 106 and tablets 108, store data which is at least partially repeated on one or more of the other devices. Further, the data stored on each of the user devices can be accessed using one or more local applications and operating system-based file managers.

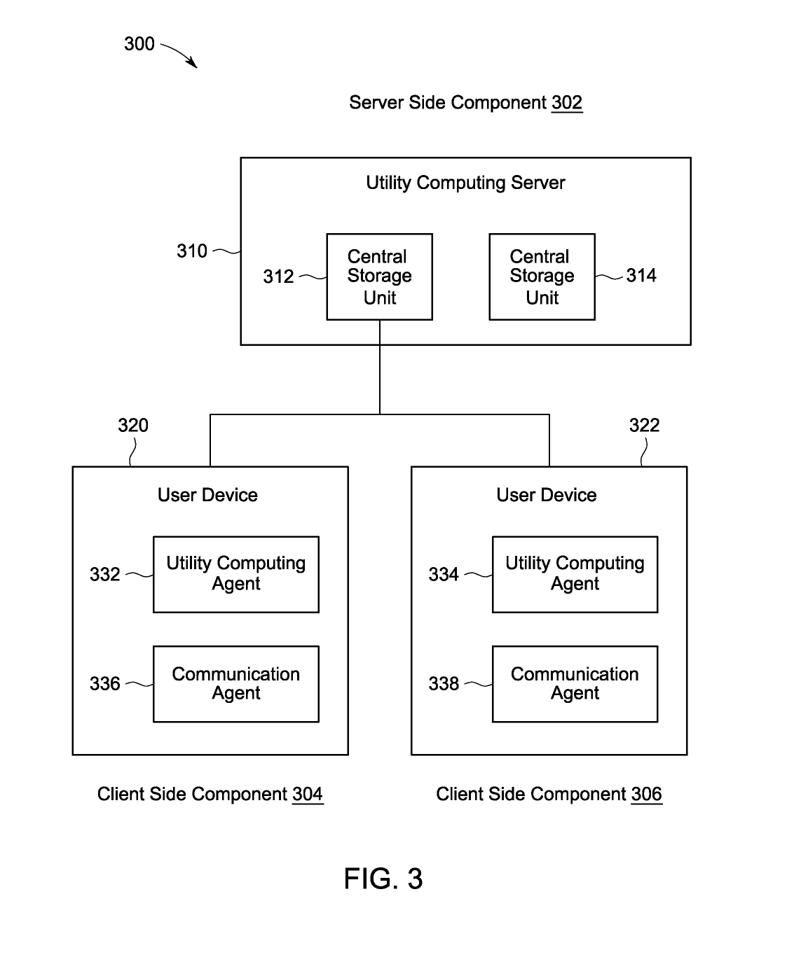

System 100 further comprises a utility computing server 110 hosting multiple central storage units similar to the central storage unit 114 shown in FIG. 1. The details about the utility computing server 110 are further explained in conjunction with FIG. 3.

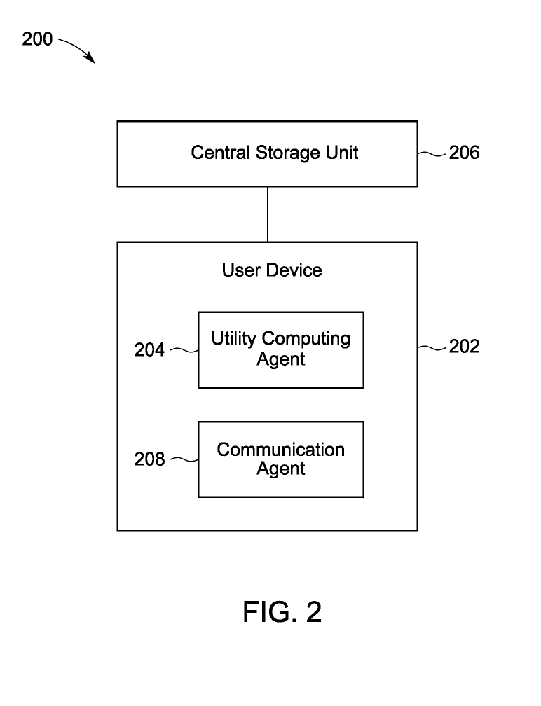

FIG. 2 shows a system 200 for communicating and managing data in a plurality of user devices 202. The system 200 comprises a utility computing agent 204 installed in each of the user devices 202, the utility computing agent 204 configured for managing data synchronization among the plurality of user devices 202, a central storage unit 206 coupled to each of the user devices 202 via a data communication network 112, the central storage unit 206 configured for being a master storage repository, and a communication agent 208 configured for communicating content from the central storage unit 206 to at least one of the user devices 202.

The utility computing agent 204 is configured for maintaining data synchronization between the central storage unit 206 and each of the user devices represented by 202. The utility computing agent 204 comprises a software module adapted to be executed by a processing unit.

Before the data stored on various user devices 202 can be synchronized, the utility computing agent 204 is configured to identity the user device 202 on which it is installed and appropriate synchronization protocols the user device 202 supports when synchronizing the data stored in the user device 202. Identifying the device and the user and identifying the appropriate synchronization protocols may be accomplished through a one time registration process that occurs when the utility computing agent 204 is installed in the user device 202. Further, the utility computing agent 204 is capable of having multiple storage areas on the user-registered device corresponding to different users. The system would synchronize with different areas in the central storage unit 206 corresponding to each user.

The utility computing agent 204 supports data synchronization protocols including at least one of: SYNCML over a remote data protocol; SYNCML over a local data protocol; IRMC; Bluetooth Phonebook Access (PBAP); RSYNC based on native platforms and AT command-based information retrieval. Further, the remote data protocol comprises TCP/IP and the local data protocol comprises Bluetooth. Still further a modified form of web based access commands like WPUT may be used in one or more user devices 202 to function as synchronization protocol.

In order to exchange and synchronize data, a communication interface is established between the central storage unit 206 and the other user devices 202. The communication interface is one of a wired and a wireless interface. Examples of wireless interface include a Bluetooth wireless interface and a Wi-Fi wireless interface. The interfaces described above are just representative examples. Any other practicable interface may be substituted between the central storage unit 206 and the user devices 202 including the smart phone, the tablets, the personal computer and the laptop.

In one embodiment, the communication interface is an application that also enables the user to access the central storage unit 206 via the public network. In one exemplary embodiment, the communication interface comprises a web browser such as MOZILLA FIREFOX®, INTERNET EXPLORER®, AOL®, SAFARI®, CHROME®, and the like.

In one embodiment, when changes are made to a file stored on one of the user devices 202, the utility computing agent 204 installed on the user device 202 on which the changes are made initiates a synchronization process with the central storage unit 206 over the TCP/IP network using the RSYNC and/or SyncML Remote protocol, for example. Subsequently, other user devices 202 storing the file may be synchronized with the central storage unit 206. The utility computing agent 204 associated with the user device 202 does not necessarily synchronize directly with the other user devices 202, but rather with the central storage unit 206.

Hence, the utility computing agent 204 installed on the user device 202 keeps track of the changes made on data that is commonly stored in the central storage unit 206 and the user device 202. Changes made to a file stored in the user device 202 are automatically synchronized with the file stored in the central storage unit 206 and vice versa.

Any changes to the data stored on the central storage unit 206 are propagated to one or more of the other user devices 202, through the subsequent synchronization of the other user device 202 with the central storage unit 206.

In an alternative embodiment, the utility computing agent 204 upon detecting changes in a file stored in the corresponding user device 202 may seek permission from the user for synchronizing the file with the central storage unit 206. Similarly, the utility computing agent 204 upon detecting changes in a file stored in the central storage unit 206 may seek permission from the user for synchronizing the file with the file stored in the corresponding user device 202.

Further, the centralized storage unit 206 may be accessed through the communication interface from one or remote devices (not shown) that do not store any of the user data. A remote device (not shown) is a communication device that is not installed with the utility computing agent 204. The remote device (not shown) merely provides access to the user to the central storage unit 206, and each of the user devices 202, where the user stores data.

When the user accesses content through the user device 202, the content may be opened in the remote device (not shown) and be streamed back to the user thereby eliminating the need for downloading the content on the user device 202. The content prior to being communicated may be transcoded and stored in a cache memory. In one embodiment, the cache memory may be a part of one of the central storage unit 206 and the remote device (not shown).

The content may comprise audio files, video files and multimedia files or documents and image files. The user in addition to accessing the content through the communication interface may also be enabled to edit the content.

The communication agent 208 comprises one or more applications that enable playing the content from the remote device (not shown) through the communication interface. Further, the communication agent 208 may be a part of one of the central storage unit 206 and each of the utility computing agents 204 installed on the user devices 202. Alternatively, the communication agent 208 may be independently installed in one or more of the user devices 202.

Turning now to FIG. 3, in another embodiment, the invention provides a cloud based managed utility computing solution. In this environment, the user's computing environment is controlled and managed by a set of applications running in a remote environment. Accordingly, the invention describes a data management system 300.

The data management system 300 comprises a server side component 302. The server side component 302 comprises a utility computing server 310 provided and maintained by a utility computing service provider. Further, the utility computing server 310 may be a physically hosted, virtually hosted and/or cloud hosted entity. The utility computing server 310 is configured to host multiple central storage units 312 and 314, each central storage unit 312 and 314 being configured for storing data corresponding to a single user and thereby each of the central storage units 312 and 314 being configured to act as a master storage repository for the associated user. Skilled artisans shall appreciate that each of the central storage units 312 and 314 may include one or more hardware components and software components to enable the central storage unit 312 to carry out the desired functions.

The utility computing server 310 allocates a predetermined amount of memory to each of the users. In one embodiment, the amount of memory allocated to each of the users may be different. Further, each of the users may be provided with an identification data and an access code that may be used by the user while accessing the central storage unit 312. This type of authentication ensures secure transmissions between the user and the central storage unit 312.

Thus, the server side component 302 controls the users who can access the central storage unit 312, the applications used, the storage available and almost all aspects of the user's computing environment. The user is enabled to access the central storage unit 312 from a communication interface installed in any computing device. The computing device includes a user device and a remote device.

Further, the data management system 300 comprises multiple client side components 304 and 306 coupled to the central storage unit 312. Each of the client side components 304 and 306 comprise utility computing agents 332 and 334 installed respectively in the user devices 320 and 322. The client side components 304 and 306 further comprise communication agents 336 and 338 respectively installed in the user devices 320 and 322. Though for the sake of simplicity, the invention is explained with respect to the client side component 304, skilled artisans shall appreciate that the invention is applicable to any other client side component represented in the form of the client side component 306.

The utility computing agent 332 installed in the user device 320 controls, manages and synchronizes at least a part of the data stored in a user's device to ensure that the user has information and access to his/her files from anywhere across the world using a browser.

The data management system 300 further comprises a communication agent 336 configured for communicating content from the central storage unit 312 to at least one of the user devices 320 and 322.

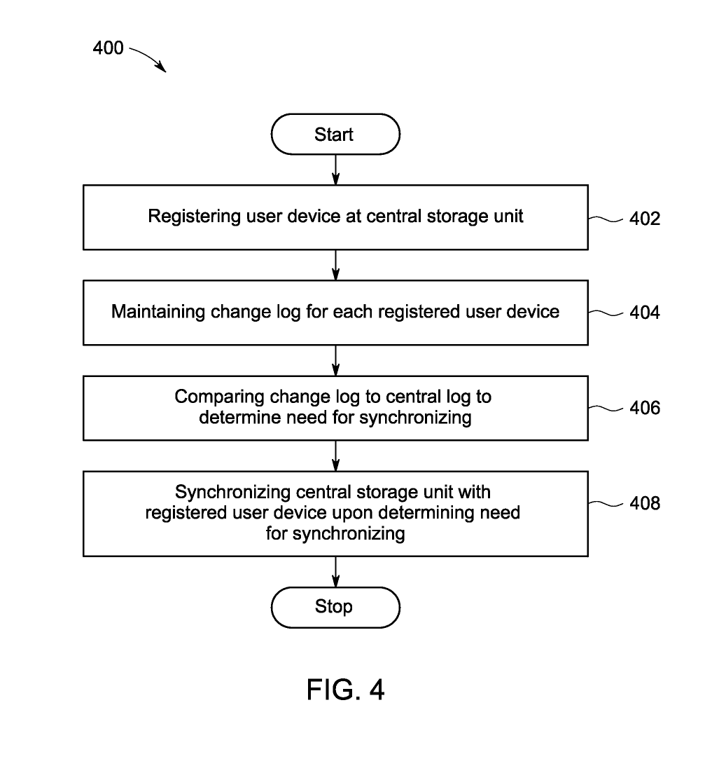

FIG. 4 illustrates a flowchart of a method 400 of communicating and managing data among a plurality of user devices 320 and 322 as described in an embodiment of the invention. The method 400 comprises steps of registering a user device 320 at the central storage unit 312 at step 402, maintaining a change log for each registered user device 320 at step 404, comparing the change log to a central log maintained at the central storage unit 312 to determine the need for synchronizing at step 406 and synchronizing the central storage unit 312 with the registered user device 320 upon determining the need for synchronizing at step 408.

The user wishing to subscribe to the utility computing service provider may select one or more user devices storing at least a part of the user data. The user data may comprise a user's personal communications, schedules, address books, contact lists, task lists, document, audio-video files, images and the like. In addition, the user data may include personal data such as contact information, address books, calendars, task lists, memos, and other information. In general, the user data may include any data that the user wishes to store in the user device 320.

Following the subscription and selection of the user devices 320 and 322, a utility computing agent 332 is automatically downloaded and installed in each of the selected user devices 320 and 322. According to this embodiment the utility computing agent 332 initiates a registration process using the communication interface available at the user device 320 for interaction with the central storage unit 312.

The method 400 of registering the user device 320 comprises identifying the user device 320 through a device identifier, determining an appropriate synchronization protocol for performing data synchronization with the user device 320 and storing the device identifier and an associated synchronization protocol identifier.

The utility computing agent 332 interrogates the associated user device 320 to determine its identification and to determine which synchronization protocols the user device 320 supports and which protocol is the most appropriate for synchronizing data between the user device 320 and the central storage unit 312. This information is utilized for registering the user device 320 at the central storage unit 312.

In addition to identifying the user device 320, the registration process identifies the interface by which the corresponding user device 320 is to communicate with the central storage unit 312. For example, hand-held portable devices may be accessed directly via a Bluetooth wireless link. Subsequent to the completion of the registration process, the data stored on the associated user device 320 may be synchronized with the data stored on the central storage unit 312 or vice versa.

In one embodiment, synchronization may occur upon receiving user commands for initiating synchronization. For each synchronization, the utility computing agent 332 employs synchronization protocols that were identified when the utility computing agent 332 was installed at the user device 320. Subsequent to the synchronization process, the utility computing agent 332 determines whether the data synchronization was successful. If not, the process is repeated and the user device 320 and the central storage unit 312 are synchronized again. When the data synchronization is successful the central storage unit 312 stores new data received from the user device 320 in non-volatile memory and the user device 320 does the same with data received from the central storage unit 312.

The central storage unit 312 maintains a change log for each registered user device 320 along with a central log indicating the number of registered devices that have been synchronized. Following the process of synchronizing with a registered user device 320, the change logs associated with the registered user device 320 are updated and further the value of the central log is incremented. The central storage unit 312 determines whether the current value of the central log equals the total number of registered user devices. If not, the data synchronization process begins anew for the succeeding registered device. In case the value stored in the central log is equal to the total number of registered devices, indicating the central storage unit 312 has been synchronized with all of the registered devices, the change logs updated during the data synchronization with each registered device are compared.

The change logs are compared in order to determine whether additional data synchronizations are necessary to ensure that all of the user data stored on all of the various registered devices is consistent across all of the devices. This is required because the central storage unit 312 synchronizes data with each registered device sequentially as and when the devices are reachable rather than synchronizing with each device simultaneously. If changes are made to the data stored on the central storage unit 312 as a result of synchronizing with the preceding device, these changes will not be reflected on all of the previously synchronized devices.

If discrepancies in the change logs are found, indicating that additional synchronization is necessary, the central log is reset to one and the process returns to where the entire synchronization process begins. However, this time through the synchronization process, the changes in the data stored on the central storage unit 312 resulting from synchronizing with the later devices will be propagated to the devices that are synchronized earlier in the process.

Thus, when the central storage unit 312 re-synchronizes with the user devices the second time, the data across all of the registered devices will be consistent. After the second pass through the synchronization process, comparing the change logs will indicate that there are no inconsistencies in the data stored on any of the registered devices or on the central storage unit 312. At this point the synchronization process ends and the utility computing agent 332 then waits for a subsequent ‘synchronize data’ command to be entered by the user.

In one embodiment, at least one local replica of the central storage unit 312 can be maintained in at least one of the user devices. The local replica can play the role of a central backup unit. For the purpose of maintaining data consistency in both the central storage unit 312 and the central backup unit, the utility computing agent 332 is configured for synchronizing the central storage unit 312 with the central back up unit on a periodic basis.

When changes are encountered in a file that is stored in both the central storage unit 312 and the central backup unit, the utility computing agent 332 is configured to request the user to resolve the conflict.

The method 400 further comprises streaming content from the central storage unit 312 to a computing device. The computing device may be a registered user device 320 or a remote device (non-registered). The method 400 of streaming comprises transcoding at least a part of the content that is to be communicated, storing transcoded content in a cache memory, communicating the transcoded content from the cache memory to the computing device. The content that is streamed over the data communication channel through the communication interface is transcoded to enable the process of streaming to function on a reduced bandwidth. The decision for transcoding and the type of streaming to be done may be based on the capability of the user end device 320 and the network the user device 320 is on.

In an exemplary embodiment, a high resolution video content may be transcoded and stored in the cache memory that is a part of one of the central storage unit 312, user devices 320 and 322, and the remote device. Upon receiving a request from the user for accessing the content at the central storage unit 312, a lower resolution video content is streamed to the user. Based on user's subscription, the transcoded content may be maintained along with the original content, or only the transcoded content may be maintained. Alternatively, the transcoding may be performed upon receiving the user request, in which case a waiting period for the user may be present.

The user may choose to retain one or both of the high and low resolution versions of content. However, the user may not be entitled to one or more of the features that the central storage unit 312 provides. The reasons for this may range from the user optionally disabling the service, the configurations of the user device 320 not permitting the user to use the service or the utility computing service provider being unable to provide the services to the user for some other reason.

In one exemplary embodiment, the user device 320 may comprise a low resolution monitor that does not support a high resolution video being streamed. Accordingly, the communication agent 336 may be configured to choose the low resolution video content to be streamed to the user. Further, in this scenario, if the user chooses not to use the transcoding mechanism and thus not have the lower resolution video content, then access to the video content may not be provided to the user.

The method 400 further comprises indexing at least a part of the data that is stored in at least one of the user devices. The process of indexing may include data that is not shared with the central storage unit 312.

The utility computing agent 332 is further configured to index the data stored in the user device 320 on which the utility computing agent 332 is installed. The data that is indexed may comprise one or more files that are not shared with the central storage unit 312 in addition to the files that are shared with the central storage unit 312. The details of the data that is indexed in the user device 320 is sent to the central storage unit 312 for storage. The index thus generated is used by the user to search for data among the multitude of user devices that the user uses.

In one embodiment, the utility computing agent 332 is configured for being a storage gateway for the user. The user is enabled to search data that is stored among the multitude of user devices. It is to be noted that data that is stored in one of the user devices 320 and not shared with the central storage unit 312 can as well be searched using the index that is stored in the central storage unit 312.

The user gaining access to the central storage unit 312 from the remote device may access and modify one or more files that are stored in the user device 320 registered for the utility computing service, provided the user device 320 is connected through the data communication network 112. Further, the user may add, modify or delete files from the remote device. The one or more files that the user gains access to may not be shared with the central storage unit 312.

The systems and methods described herein may support any user device 320 such as any standard computer such as a minicomputer, a microcomputer, a UNIX® machine, LINUX® machine, mainframe machine, super computer, personal computer (PC) such as INTEL®, APPLE®, or SUN® based processing computer or clone thereof, personal digital assistant (PDA), wearable computer, cellular phone with wide area network access capability, tablets (such as iPad®, ANDROID® based tablets, etc.), MP3 player or other portable entertainment device having wide are network access capability (e.g., iPod, available from Apple, Cupertino, Calif.), laptop, notebook, or other appropriate computer, such as home appliances, televisions, stereos, audio and/or video recording devices, security devices and other devices having an embedded processor capable of wide area network access.

Further, each user device 320 may include typical computer components (not shown), such as a motherboard, central processing unit (CPU), memory in the form of random access memory (RAM), hard disk drive, display adapter, other storage media such as diskette drive, CD-ROM, DVD-ROM, CD-RW, DVD-RW, flash-ROM, tape drive, PCMCIA cards and/or other removable media, a monitor, keyboard, mouse and/or other user interface, a modem, network interface card (NIC), Bluetooth® and/or other conventional input/output devices. In many embodiments, user devices comprise conventional desktop or “tower” machines, but can alternatively comprise portable or “laptop” computers, notebook computers, handheld personal digital assistants (PDAs) or “palm-top” computers, tablet computers, cellular phones capable of browsing Web pages, “dumb terminals” capable of browsing Web pages, internet terminals capable of browsing Web pages such as WEBTV®, or other Web browsing or network-enabled devices.

Each user device 320 may comprise, loaded in its memory, an operating system 300 (not shown) such as UNIX®, WINDOW®, LINUX®, Apple OS®, PALM OS®, ANDROID® or the like, or a proprietary operating system 300. Each user device 320 may further have loaded in the memory a Web Browser program such as MOZILLA FIREFOX®, NETSCAPE NAVIGATOR®, INTERNET EXPLORER®, AOL®, SAFARI®, CHROME®, or like browsing software for the computers.

The utility computing server 310, provided by the utility computing service provider, that hosts the central storage unit 312 may be any standard data processing device or computer, including a minicomputer, a microcomputer, a UNIX® or LINUX® machine, a mainframe machine, super computer, a personal computer (PC) such as an INTEL® based processing computer or clone thereof, an APPLE® computer or clone thereof or, a SUN® workstation, wearable computer, or other appropriate computer. Utility computing server 310 may include conventional components (not shown) such as a motherboard, central processing unit (CPU), random access memory (RAM), hard disk drive, display adapter, other storage media such as diskette drive, CD-ROM, DVD-ROM, CD-RW, DVD-RW, flash-ROM, tape drive, PCMCIA cards and/or other removable media, a monitor, keyboard, mouse and/or other user interface means, a modem, network interface card (NIC), and/or other conventional input/output devices. Multiple utility computing servers may be used, as described further below.

The utility computing server 310 has stored in its memory a server operating system 300 (not shown) such as UNIX®, WINDOWS® NT, NOVELL®, SOLARIS®, LINUX® or other server operating system 300, or a proprietary sever operating system 300 (e.g., NEC or other proprietary system 300). The utility computing server 310 also has loaded in its memory web server software such as Apache-TOMCAT®, IBM WEBSPHERE®, Oracle WEBLOGIC®, NETSCAPE®, INTERNET INFORMATION SERVER®. (IIS), or other appropriate web server software loaded for handling HTTP (hypertext transfer protocol) or Web page requests from user devices. The utility computing server 310 may also comprise a connection handler array configured to establish and maintain a plurality of network connections between a plurality of clients and one or more network-enabled devices.

The present arrangement permits access and sharing of data to and from any location throughout the world which is accessible through a network that the devices/computers can communicate over. Although the Internet is the most ubiquitous and common network to be mentioned here, the present invention is not limited to only use over the Internet, as other networks, private as well as public may also employ this functionality. Using the example of the internet, a user on a laptop or other portable computer, who is traveling, for example, can access any of the other devices shown, including home computer and office system 300 to obtain current, up-to-date files that may be needed, which perhaps the user forgot to take on the trip, or which may have been edited or updated since the time of the user's departure. Further, the present invention allows collaboration, so the remotely located user can collaboratively work with files in other locations, with other users.

Thus, for example, a user who is away from his or her main stores of data may access, use and even download files with a device such as a tablet, PDA, MP3 player or cell phone having wireless network access capability. It is noted that the present invention is not limited to the computers/devices shown, but may be used by any network-accessible devices for communicating data files over a network, examples of which include cameras, video and/or audio recording equipment, televisions, factory equipment, instruments, office equipment such as printers, fax machines, scanners, home security equipment, home appliances and others, including those listed above in the specification.

Many of the advantages provided by the system and method of communicating and managing data among the plurality of user devices described in various embodiments are listed below.

A user may subscribe to the utility computing service provider for the services and subsequently, the utility computing agent is automatically downloaded, installed and configured on each of the user device selected by the user. This eliminates the need for human intervention.

The user can store data that he/she wishes to gain access to, from a remote location. The central storage unit stores multiple copies of one or more designated files that the user wishes to manipulate. Further, the central storage unit supports various types of operating systems (OS) and user devices (from smart phones to computers).

The system and method described herein combines centralized cloud based storage with backup and browser based access. Further, it extends to being a storage gateway for the user. Hence, the system and method described herein enable the user to access most of the user data available on multiple user devices that are connected to the data communication network.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for communicating and managing data in a plurality of user devices, the system comprising:
a utility computing agent installed in each of the user devices, the utility user device agent configured for managing data synchronization among the plurality of user devices;
a central storage unit coupled to each of the user devices via a data communication network, the central storage unit configured for being a master storage repository; and
a communication agent configured for communicating content from the central storage unit to at least one of the user devices.

2. The system of claim 1, wherein each of the user devices is configured for accessing the central storage unit via a communication interface.

3. The system of claim 1, wherein each of the user devices is configured for storing data that can be accessed using one or more local applications and operating system-based file managers.

4. The system of claim 1, wherein the central storage unit is configured for allocating a predetermined amount of memory for each user.

5. The system of claim 2, wherein the communication interface is a web browser.

6. A personal information management system for managing data among a plurality of user devices each adapted to store data of a user, the personal information management system comprising:
a server side component comprising:
a central storage unit adapted to interface with each of the user devices via a data communication network, the central storage unit configured for being a master storage repository;
a client side component comprising:
a utility computing agent installed in each of the user devices, the utility computing agent configured for managing data synchronization among the plurality of user devices, the utility computing agent configured for supporting a plurality of data synchronization protocols for synchronizing data with the plurality of user devices; and
a communication agent configured for communicating content from the central storage unit to at least one of the user devices.

7. The personal information management system of claim 6, wherein the communication agent is a part of the utility computing agent.

8. The personal information management system of claim 6, wherein the user device is configured for accessing the central storage unit via a communication interface.

9. The personal information management system of claim 6, wherein the user device comprises multiple storage units, and wherein each of the storage units corresponds to a single user.

10. The personal information management system of claim 9, wherein the utility computing agent is configured to synchronize with multiple areas in the central storage unit, each area in the central storage unit corresponding to a single user.

11. The personal information management system of claim 6, further comprising a central backup unit, the central backup unit configured for storing a replica of the central storage unit.

12. The personal information management system of claim 11, wherein the central backup unit is a part of at least one of the user devices.

13. A method of communicating and managing data in a plurality of user devices, the method comprising:
registering a user device at a central storage unit;
maintaining a change log for each registered user device;
comparing the change log to a central log maintained at the central storage unit unit to determine the need for synchronizing; and
synchronizing the central storage unit with the registered user device upon determining the need for synchronizing.

14. The method of claim 13, wherein registering a user devices comprises:
identifying a user device having a device identifier;
determining an appropriate synchronization protocol for performing data synchronization with the user device; and
storing the device identifier and an associated synchronization protocol identifier.

15. The method of claim 13, wherein synchronizing the central storage unit comprises:
initiating a data synchronization function with a registered user device employing a synchronization protocol corresponding to the synchronization protocol identifier stored in association with the device identifier.

16. The method of claim 13, further comprising:
indexing at least a part of the data that is stored in at least one of the user devices.

17. The method of claim 13, further comprising:
synchronizing the central storage unit with a central back up unit on a periodic basis.

18. The method of claim 13, further comprising:
streaming content from the central storage unit to a computing device, wherein the computing device comprises a user device registered for a utility computing service and a remote device that is not registered for the utility computing service.

19. The method of claim 18, wherein streaming comprises:
transcoding at least a part of the content that is to be communicated;
storing transcoded content in a cache memory; and
communicating the transcoded content from the central storage unit to the computing device.

20. The method of claim 16, further comprising
selecting the process of transcoding and type of streaming to be performed based on the configuration of the user device and a data communication network that networks the user device.
